(19) United States
(12) Patent Application Publication
(10) Pub. No.: US 2012/0136878 A1
(43) Pub. Date: May 31, 2012

(54) APPLYING HIERARCHY INFORMATION TO DATA ITEMS

(76) Inventors: RAYMOND CYPHER, Sherwood Park (CA); RICHARD WEBSTER, Richmond (CA)

(21) Appl. No.: 12/954,686

(22) Filed: Nov. 26, 2010

(51) Int. Cl. G06F 17/30

(52) U.S. Cl. 707/752; 707/E17.044; 707/E17.061

(57) ABSTRACT

Various embodiments of systems and methods for applying hierarchy information to data items are described. The methods include organizing data items hierarchically when the data items contain no hierarchy information and more particularly applying a hierarchy from a different source or a hierarchy just being created by the user to the data items to produce a hierarchical structure of the data items following the external hierarchy, the relationship between the entities in the external hierarchy and its depth of dependencies. The data items are arranged (ordered and nested) and filtered based on the hierarchy provided. In addition, hierarchical totals may be calculated using the newly produced hierarchy.

### FIELD

The field generally relates to the software arts, and, more specifically, to methods and systems for applying hierarchy information to data items.

### BACKGROUND

A hierarchy is an arrangement of entities in which the entities are represented as being above, below, or at the same level one to another. The hierarchy is simply an ordered set or an acyclic graph. The entities in the hierarchy can be linked directly or indirectly, vertically or horizontally. A system that is largely hierarchical can also include alternative hierarchies. Indirect hierarchical links can extend the hierarchy vertically upwards or downwards via multiple links in the same direction, following a path. All parts of the hierarchy which are not linked vertically one to another can be associated horizontally through a path or a level. A hierarchy can be a nested hierarchy, when it contains a hierarchy of hierarchies.

In a hierarchy, the data can be organized in a tree structure. A data model, in which the data is organized in a tree structure, is a hierarchical data model. The structure allows repeating information using parent/child relationships: each parent can have many children but each child only has one parent. All attributes of a specific record are listed under an entity type. In a database, an entity type is the equivalent of a table; each individual record is represented as a row and an attribute as a column Entity types are related to each other using one-to-many relationships, also known as 1: N mapping. An organization could store employee information in a table that contains attributes/columns such as employee number, first name, last name, and department number. The organization provides each employee with computer hardware as needed, but computer equipment may only be used by the employee to which it is assigned. The organization could store the computer hardware information in a separate table that includes each part's serial number, type, and the employee that uses it. In this model, the employee data table represents the “parent” part of the hierarchy, while the computer table represents the “child” part of the hierarchy. Each employee may possess several pieces of computer equipment, but each individual piece of computer equipment may have only one employee owner.

Often, there is the need to organize given data items into a hierarchy or hierarchies. The data items themselves may not contain the information necessary to create the desired hierarchy. Some databases provide hierarchy information for the data they contain and can apply this hierarchy information to the results of queries to the database. However, these hierarchies are defined within the system and are tightly coupled to the data to which they apply and originate from the same source as the data. In addition, the hierarchical relationships are often encoded in the relational data itself. For example, a data item having a field that references the parent's identifier (ID) value. Again, the hierarchy information is bound to the data itself.

### SUMMARY

Various embodiments of systems and methods for applying hierarchy information to data items are described herein. In various embodiments, the method includes loading an external hierarchy structure including a plurality of entities as nodes of the external hierarchy structure, wherein each entity in the plurality described with a first set of properties. A property is identified from the first set of properties that is common for the plurality of entities and for a plurality of data items, wherein each data item is described with a second set of properties. Then, the plurality of data items is sorted according to a value of the property and one or more data items are identified from the plurality of data items that correspond to an entity from the external hierarchy structure based on the value of the property. Finally, the entity from the external hierarchy structure is linked to the one or more data items.

In various embodiments, the system includes an external hierarchy structure including a plurality of entities as nodes, wherein each entity in the plurality is described with a first set of properties. Further, the system includes a database storage unit for storing a plurality of data items, wherein each data item is described with a second set of properties. Also, the system includes a processor in communication with the database storage unit, the processor to load the external hierarchy structure and identify a property from the first set of properties that is common for the plurality of entities and for the plurality of data items. The processor also sorts the plurality of data items according to a value of the property and identifies one or more data items from the plurality of data items that correspond to an entity from the external hierarchy structure based on the value of the property. Finally, the processor links the entity from the external hierarchy structure to the one or more data items.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an external hierarchy definition structure 100.

FIG. 2 is a block diagram illustrating a table of data items with associated values and properties.

FIG. 3 is a block diagram illustrating mapping of hierarchy entities to data items, according to an embodiment.

FIG. 4 is a block diagram illustrating ordering data items by the external hierarchy definition.

FIG. 5 is a block diagram illustrating data presented in hierarchical order with sum operation performed for each data item.

FIG. 6 is a block diagram illustrating inconsistencies between hierarchy entities and data items.

FIG. 7 is a flow diagram illustrating the method of mapping hierarchy entities to data items, according to an embodiment.

FIG. 8 is a block diagram illustrating an exemplary computer system 800.

### DETAILED DESCRIPTION

Embodiments of techniques for applying hierarchy information to data items are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

In various embodiments, an externally provided hierarchy definition can be used to organize the data items into a hierarchy following the structural organization of this externally provided hierarchy.

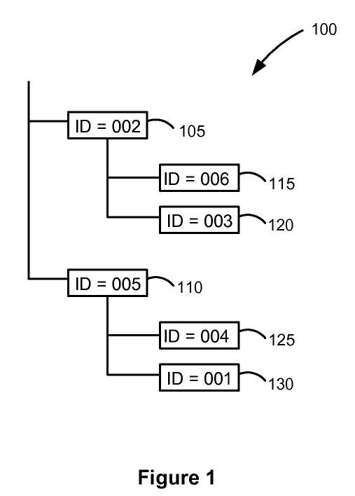

FIG. 1 is a block diagram illustrating an external hierarchy definition structure 100. The external hierarchy definition structure 100 is loaded from a user specified location. This could be a database, a user specified text file, and so on. Hierarchy definitions may be provided from diverse external sources. For example, they may be manually created by a user or derived from information in a location or system separate from the data items being processed. In addition, the hierarchy definition may be created on-the-fly at the time of processing or may be created and stored in a storage unit for multiple uses. The external hierarchy definition structure 100 contains information defining the relationship between the entities in the hierarchy. This includes, but is not limited to, specifying a unique identifying value for each entity in the hierarchy and the parent/child relationships between these entities. External hierarchy definition structure 100 includes a set of parent entities such as parent entity 105 and 110. Parent entity 105 includes a set of child entities such as child entities 115 and 120. Parent entity 110 includes a set of child entities such as child entities 125 and 130. Both, the parent entities and child entities, have unique identifying values or properties associated with them. For example, parent entity 105 has a unique identifying value ID=002.

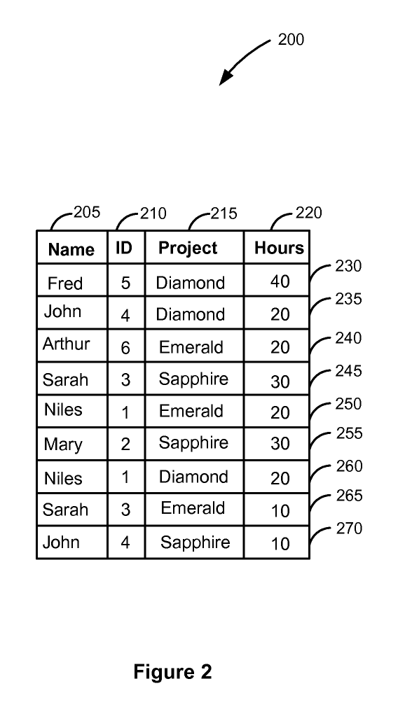

FIG. 2 is a block diagram illustrating a table of data items with associated values and properties. In various embodiments, a data item might be a record, or set of records, from a database. Table 200 includes, but is not limited to, the following properties describing each data item: name 205, ID 210, project 215, and hours 220. Table 200 contains data describing a given employee by name and ID, on which project he or she is working, and how many hours the employee spends on the project. For example, the first data item 230 of table 200 includes the following associated values: name=Fred, ID=005, project=Diamond, and hours=40. Each data item (each row) in table 200 has at least one associated value, which corresponds to an identifying value in the hierarchy definition. For example, in table 200, the associated value that corresponds to an identifying value in the external hierarchy definition structure 100 is the ID property. For data item 230, the ID is 005 which corresponds to the identifying value of parent entity 110. Table 200 further contains data items 235, 240, 245, 250, 255, 260, 265, and 270.

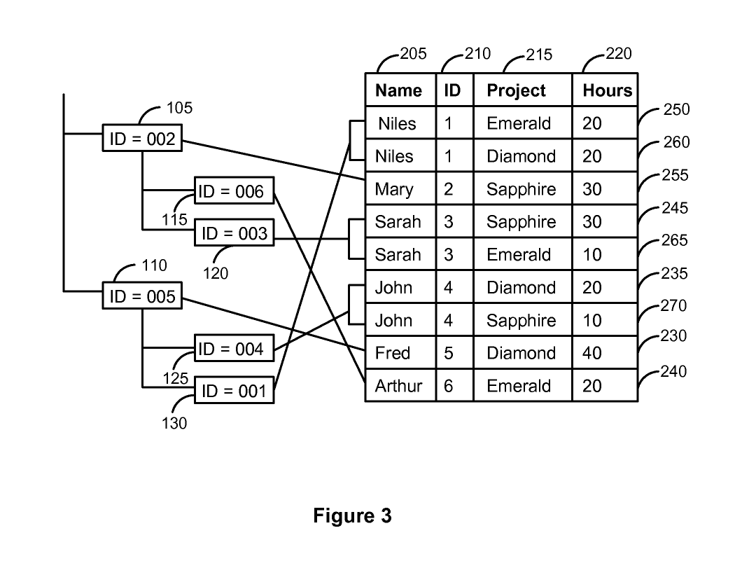

FIG. 3 is a block diagram illustrating mapping of hierarchy entities to data items, according to an embodiment. In various embodiments, the user specifies a property of the entities in the external hierarchy definition and the corresponding property of the data items, based on which the mapping will be performed. In the case of external hierarchy definition structure 100 and table 200, the ID property of the hierarchy entities corresponds to the ID property in the data items. Therefore, the ID property will be the basis for the mapping. The first step of the mapping process is sorting the data items by the value of the specified property (e.g., the ID property). This allows searching on the ID value to find the range of data items corresponding to each entity in the hierarchy. The entities are then linked to the corresponding data item(s). FIG. 3 shows the ordering of the data items of table 200 according to their ID value. In result of the sorting, the data items are ordered in the following way: 250, 260, 255, 245, 265, 235, 270, 230, and 240.

Further, the entities of external hierarchy definition structure 100 are linked to the corresponding data items. For example, parent entity 110 has ID=005 and data item 230 had ID=005 and thus, the entity 110 is linked to data item 230. There may be the case where one hierarchy entity is linked to more than one data item. As a result, parent entity 105 is linked to data item 255; child entity 115 is linked to data item 240; child entity 120 is linked to data items 245 and 265; child entity 125 is linked to data items 235 and 270; and child entity 130 is linked to data items 250 and 260.

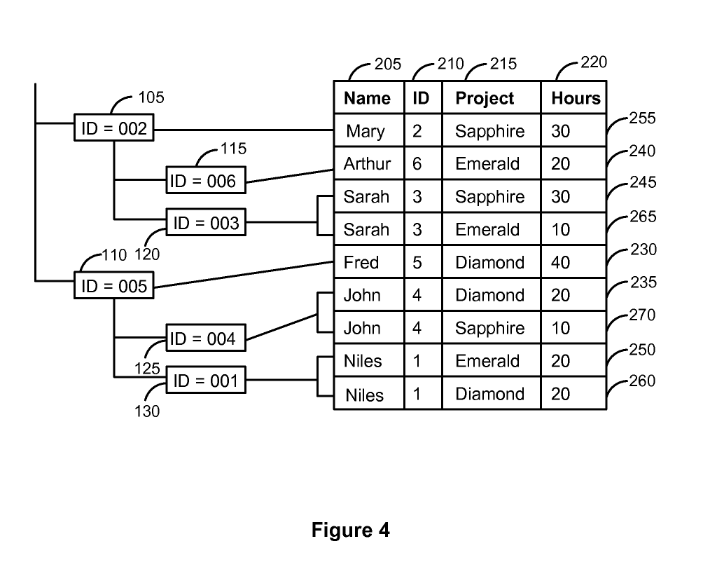

FIG. 4 is a block diagram illustrating ordering of data items by the external hierarchy definition. Once the links have been established between the hierarchy entities and the data items, the data items can be ordered based on the external hierarchy definition. Then the information can be presented based on hierarchical ordering, depth in the hierarchy, and so on. FIG. 4 shows the new ordering of the data items in table 200. This ordering corresponds to the ordering in the external hierarchy definition structure 100. In this way, the data items are organized in a hierarchical structure having parent and child nodes. As a result, the data items are ordered in the following way: 255, 240, 245, 265, 230, 235, 270, 250, and 260. In the new structure, data items 255 and 230 are parent nodes, as data item 255 has data items 240, 245, and 265 as child nodes. Data item 230 has data items 235, 270, 250, and 260 as child nodes.

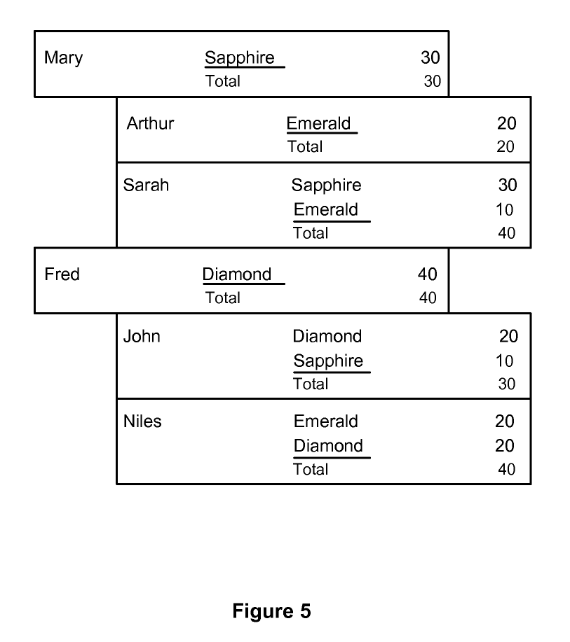

FIG. 5 is a block diagram illustrating data presented in hierarchical order with sum operation performed for each data item. After the data items are ordered according to the external hierarchy definition, the user can perform operations on the data items (for example, calculating the total hours an employee spent on all projects). FIG. 5 shows an exemplary hierarchical order with sum calculations for the data items that correspond to a given hierarchy entity. For example, data items 235 and 270 correspond to hierarchy entity 125. Therefore, the calculations on data items 235 and 270 lead to summing the total hours the employee John has spent on both projects, Diamond and Sapphire (i.e., 30 hours).

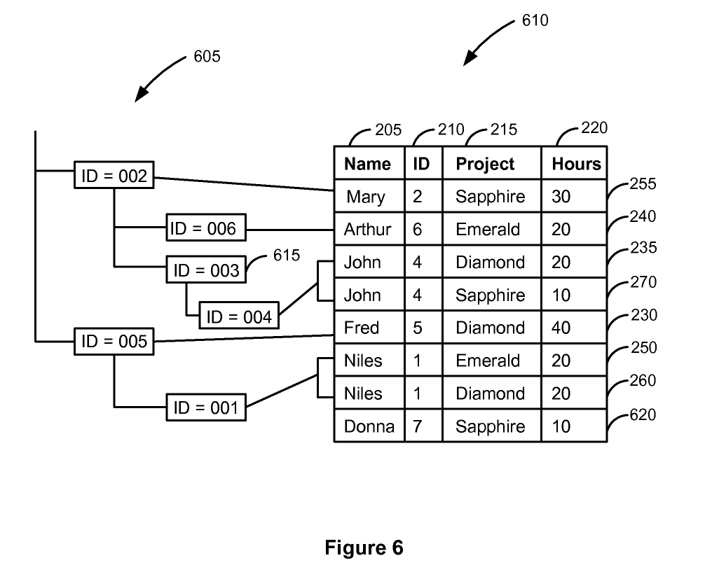

FIG. 6 is a block diagram illustrating inconsistencies between hierarchy entities and data items. In various embodiments, the mapping between the data items and the hierarchy definition may be incomplete. This may occur when there is no data item corresponding to an entity in the hierarchy definition or an entity with no corresponding data item. This situation can result in orphaned data items. An orphaned data item is a data item for which the parent data item does not exist in the set of data items being processed. FIG. 6 shows an external hierarchy definition 605 and table 610 with a plurality of data items. In this case of mapping, there are no data items for entity node 615 and there is no corresponding entity node for data item 620. For data items with no corresponding node, the user can choose to either discard the data items or to treat them as if they corresponded to a top level node in the hierarchy. In table 610, the data items for John (235 and 270) are orphaned as they do not have a parent data item in the produced hierarchy of data items (since the John data items correspond to entities with ID=004, which parent node is entity node 615, which does not link to any data items). In some embodiments, the orphaned data item may be discarded. In other embodiments, the orphaned data item may be retained without a parent data item, effectively making it an extra top level node in the hierarchy of data items. In some other embodiments, the gap produced by the missing data item may be bridged. In this case, the hierarchy definition is used to progress up the chain of parents from the orphaned data item until an ancestor is found for which a corresponding data item exists. The orphaned data item is then made a child of this ancestor data item. In some embodiments, the gap produced by the missing data item may be filled by creating a dummy data item.

Regardless of which option is used to handle orphaned data items, information about the data items that were orphaned and the corresponding solution is recorded. This allows clients using the resulting hierarchy of data items to handle these portions of the hierarchy in an appropriate fashion. For example, dummy data items or bridged connections could be displayed differently to make the user aware of the discrepancy between the data items and the hierarchy definition.

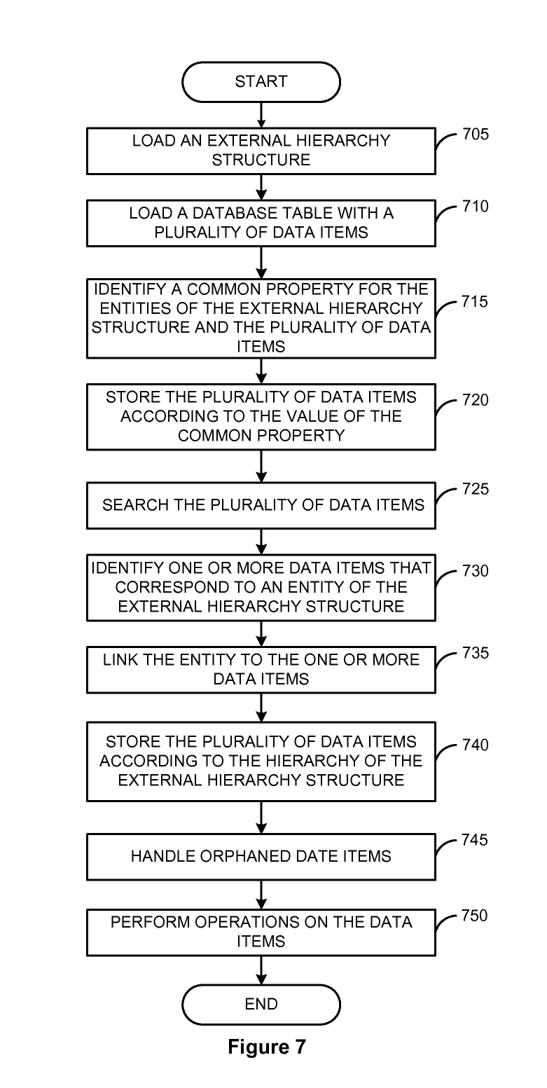

FIG. 7 is a flow diagram illustrating the method of mapping hierarchy entities to data items, according to an embodiment. In various embodiments, the external hierarchy definition is used to both filter and organize the data items. The filtering takes place when data items that do not have a corresponding identifying value in the hierarchy definition are discarded. The data items are organized into a hierarchy by querying the external hierarchy definition for the parent child relationships specified for each identifying value. This information is then used to create an appropriate data structure which organizes the data items into a hierarchy. Because the hierarchy definition is externally provided, rather than being inherent in the data items being processed, multiple external hierarchy definitions can be applied to the same set of data items. Each hierarchy definition will produce a different arrangement, and possibly a sub-set, of the data items. This allows different users to organize the data items based on their needs without affecting the original data items or interfering with other users abilities to impose their own organization on the items.

At block 705, an external hierarchy structure is loaded. The external hierarchy structure is a hierarchy definition that is external to the data items that need to be organized. The external hierarchy definition structure (e.g., hierarchy structure 100) can be loaded from a location or system that is separate from the one containing the data items. The external hierarchy structure contains a number of entities as nodes of the hierarchy. The hierarchy definition contains information (properties and values) defining the relationship between the entities in the hierarchy. At block 710, a plurality of data items is loaded from a database table. The data items in the plurality are not ordered in any fashion. Each data item is described and stored in the database with a set of properties. There should be at least one property value of a data item that matches a property value of an entity from the external hierarchy structure, so these two elements to be linked. At block 715, a common property is identified for the entities of the external hierarchy structure and the plurality of data items. At block 720, the data items in the plurality are sorted according to the value of the common property for each data item. At block 725, the plurality of data items are searched based on the common property value to find the range of items corresponding to each entity in the external hierarchy structure.

At block 730, one or more data items are identified to correspond to an entity in the external hierarchy structure based on the common property value. At block 735, the corresponding entity is linked to the identified one or more data items. All entities that have in common some of the data items the same value of the common property are linked to these data items. At block 740, the data items in the plurality are sorted according to the hierarchy organization of the external hierarchy definition structure. As a result, a hierarchy of data items is produced as a structure following the hierarchy of the external hierarchy structure. The new hierarchy of data items also follows the relationship of the entities and the depth of dependencies of the external hierarchy structure. At block 745, the orphaned data items are handled according to user's preferences. In some embodiments, for data items with no corresponding entity in the external hierarchy structure, the user can choose to either discard the data items or to treat them as if they corresponded to a top level node in the hierarchy. In other embodiments, the gap produced by the missing data item may be bridged or may be filled by creating a dummy data item. At block 750, operations may be performed on the data items in the new structure. Examples of operations are report processing operations. Data is extracted from data source as specified by a report schema, also specifying how data is to be processed and formatted. In some embodiments, the report is a business intelligence (BI) document such as a Crystal Report® or SAP® BusinessObjects™ Web Intelligence® report.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

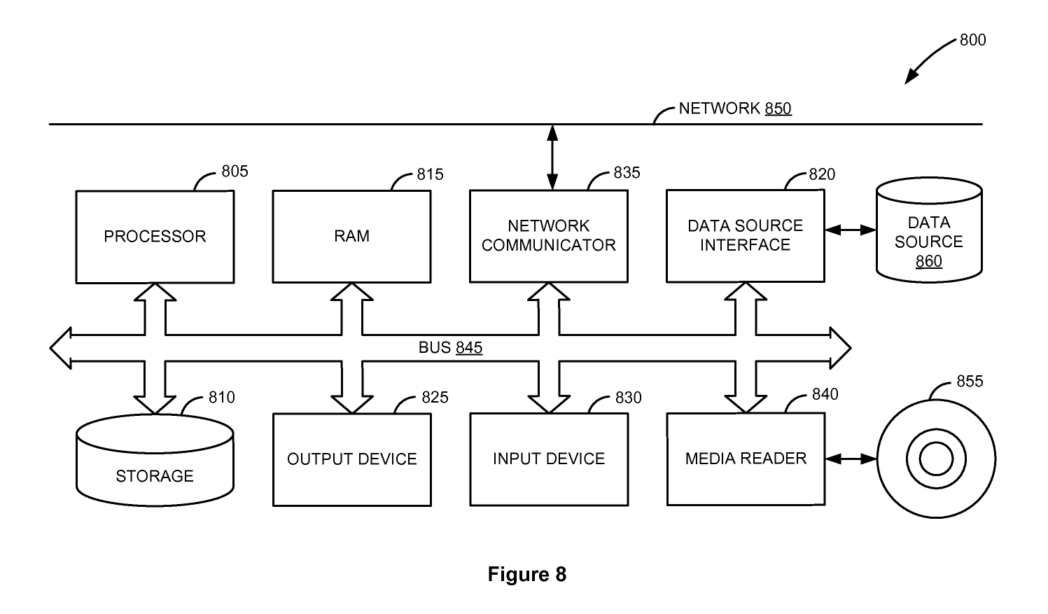

FIG. 8 is a block diagram illustrating an exemplary computer system 800. The computer system 800 includes a processor 805 that executes software instructions or code stored on a computer readable storage medium 855 to perform the above-illustrated methods of the invention. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be access via one or more abstraction layers implemented in hardware or software. For example, the data source 860 may be access by network 850. In some embodiments the data source 860 may be accessed via an abstraction layer, such as, a semantic layer.

A data source 860 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a computer readable storage medium to tangibly store instructions, which when executed by a computer, cause the computer to:
load an external hierarchy structure including a plurality of entities as nodes of the external hierarchy structure, each entity in the plurality of entities described with a first set of properties;
identify at least one property from the first set of properties that is common for the plurality of entities and for a plurality of data items, wherein each data item is described with a second set of properties;
sort the plurality of data items according to a value of the property;
identify one or more data items from the plurality of data items that correspond to an entity from the external hierarchy structure based on the value of the property; and
link the entity from the external hierarchy structure to the one or more data items.

2. The article of manufacture of claim 1, wherein the instructions that cause the computer to identify one or more data items cause the computer to search the plurality of data items based on the value of the property to find the one or more data items that correspond to the entity from the external hierarchy structure.

3. The article of manufacture of claim 1, wherein the instructions further cause the computer to:
link rest of the entities from the external hierarchy structure to rest of the data items in the plurality of data items that have the same value of the property;
sort the plurality of data items according to the external hierarchy structure; and
produce a hierarchy from the plurality of data items, the hierarchy following the external hierarchy structure.

4. The article of manufacture of claim 3, wherein the instructions further cause the computer to handle an orphaned data item, the orphaned data item producing a gap in the hierarchy.

5. The article of manufacture of claim 4, wherein the instructions further cause the computer to organize the orphaned data item as a top level node in the hierarchy.

6. The article of manufacture of claim 4, wherein the instructions further cause the computer to bridge the gap in the hierarchy via an ancestor of the orphaned data item in the external hierarchy structure.

7. The article of manufacture of claim 4, wherein the instructions further cause the computer to create a dummy data item to fill in the gap in the hierarchy.

8. A computerized method comprising:
loading an external hierarchy structure including a plurality of entities as nodes of the external hierarchy structure, wherein each entity in the plurality of entities is described with a first set of properties;
identifying at least one property from the first set of properties that is common for the plurality of entities and for a plurality of data items, wherein each data item is described with a second set of properties;
sorting the plurality of data items according to a value of the property;
identifying one or more data items from the plurality of data items that correspond to an entity from the external hierarchy structure based on the value of the property; and
linking the entity from the external hierarchy structure to the one or more data items.

9. The method of claim 8, wherein identifying the one or more data items comprises searching the plurality of data items based on the value of the property to find the one or more data items that correspond to the entity from the external hierarchy structure.

10. The method of claim 8, further comprising:
linking rest of the entities from the external hierarchy structure to rest of the data items in the plurality of data items that have the same value of the property;
sorting the plurality of data items according to the external hierarchy structure; and
producing a hierarchy from the plurality of data items, the hierarchy following the external hierarchy structure.

11. The method of claim 10, further comprising handling an orphaned data item, the orphaned data item producing a gap in the hierarchy.

12. The method of claim 11, further comprising organizing the orphaned data item as a top level node in the hierarchy.

13. The method of claim 11, further comprising bridging the gap in the hierarchy via an ancestor of the orphaned data item in the external hierarchy structure.

14. The method of claim 11, further comprising creating a dummy data item to fill in the gap in the hierarchy.

15. A computing system comprising:
a memory comprising an external hierarchy structure including a plurality of entities as nodes, wherein each entity in the plurality of entities described with a first set of properties;
a database storage unit for storing a plurality of data items, wherein each data item is described with a second set of properties;
a processor in communication with the database storage unit, the processor configurable to:
load the external hierarchy structure;
identify at least one property from the first set of properties that is common sort the plurality of data items according to a value of the property;
identify one or more data items from the plurality of data items that correspond to an entity from the external hierarchy structure based on the value of the property; and
link the entity from the external hierarchy structure to the one or more data items.

16. The computing system of claim 15, further comprising a hierarchy produced by linking the entity from the external hierarchy structure to the one or more data items from the plurality of data items, the hierarchy following the external hierarchy structure.

17. The computing system of claim 16, further comprising an orphaned data item in the hierarchy, the orphaned data item producing a gap in the hierarchy.

18. The computing system of claim 17, wherein the orphaned data item is organized as a top level node in the hierarchy.

19. The computing system of claim 17, further comprising a dummy data item to fill in the gap in the hierarchy.

20. The computing system of claim 17, further comprising an ancestor of the orphaned data item in the external hierarchy structure to bridge the gap in the hierarchy.
